(19) United States
(12) Patent Application Publication
(10) Pub. No.: US 2003/0043148 A1
(43) Pub. Date: Mar. 6, 2003

(54) Method for accelerated triangle occlusion culling

(76) Inventors: Lin-Tien Mei, Hsinchu (TW); Chung-Yen Lu, Taipei (TW); Kuo-Wei Yeh, Miaoli (TW)

Correspondence Address: NIXON PEABODY, LLP, 8180 GREENSBORO DRIVE, SUITE 800, MCLEAN, VA, 22102, US

(21) Appl. No.: 10/038,811

(22) Filed: Jan. 8, 2002

(30) Foreign Application Priority Data
Sep. 6, 2001 (TW) 090122155

(51) Int. Cl. G06T 15/40

(52) U.S. Cl. 345/421

(57) ABSTRACT

The present invention discloses a method for accelerated triangle occlusion culling in the computer graphic system. The triangle-based visibility testing is determined by using a triangle within a particular group of Coarse-Z buffer. If the triangle within a particular group of Coarse-Z buffer is hidden, then the triangle will be discarded. By using triangle-based visibility pre- test determined by the Coarse-Z buffer, the graphics system can skip hidden surface at a great lick and the requirement of memory bandwidth and unnecessary computations is eliminated.

### FIELD OF THE INVENTION

The present invention relates to method for graphics processing and more particularly to method for accelerated triangle occlusion culling.

### BACKGROUND OF THE INVENTION

In 3D computer graphics applications, an object in a scene is represented by 3-D graphical model. Using polygon meshes, for example, the surface of an object is modeled with multiple interconnected polygons. The rendering process typically begins by transforming the vertices of the geometric primitives (polygons or triangles) to prepare the data for the rasterization process. Rasterization generally refers to a computation process of values for a pixel. The process computes the data of the geometric primitives that project onto the pixel.

In a given 3-D graphics scene, a number of polygons may project onto the same area of the projection plane. As such, some primitives may not be visible in the scene. Therefore, many hidden surface removal algorithms are developed to remove the overlapping facets when objects project onto the same area of the projection plane. One of the well-known algorithms is the Z-buffer algorithm using a Z-buffer to store the depth value of each drawing point. The kernel of Z-buffer algorithm involves a depth comparison mechanism. The depth comparison mechanism is provided for comparing each incoming point's depth value with the depth value stored in the Z-buffer.

For a point (x,y) on the facet, the depth value can be derived by an interpolation between the depth values of vertices of the facet. The depth value corresponding to coordinate (x,y), are retrieved from the Z-buffer. A depth test is invoked to determine which point is closer to the viewer by comparing two depth values. The Z-buffer is then updated with the closer depth value. Therefore, the Z-buffer reflects the status of closest depth values so far encountered for every point in the projection plane. For instance, assume that the viewer is positioned at the origin with z coordinate equal to zero. Moreover, the viewing direction is toward the positive z-axis. Then, the Z-buffer is used to store the smallest z value so far encountered for the drawing points.

The required memory bandwidth of reading 32 bit Z-buffer for a four-pixel-pipeline graphics rendering system at a 150 MHz operation frequency is more than 2Gbytes per second. It is clear that graphics performance will be restricted by the local memory bandwidth. In accordance with the method of Coarse-Z test (tile-based Z buffer or Hierarchical Z buffer), the required memory bandwidth of determining visibility have been reduced since only a small portion of pixels need to proceed a Z-test.

FIG. 1 and FIG. 2 illustrate the prior art method of tile-based Z test. As shown in FIG. 1, the computer displays two triangles 12, 14, and the first triangle 12 is in the foreground in the overlapped areas. The computer graphics system defines a reference coordinate system which includes a plurality of tiles. A Coarse-Z buffer is provided for storing the maximum depth value of each tile. The initial values stored in the Coarse-Z buffer are 1.0 (background position).

With reference now to FIG. 2, it illustrates the operations of Coarse-Z test and the status of tile (7,4). The minimum and maximum depth values of the first triangle 12 within tile (7,4) are assumed to be 0.2 and 0.4 respectively. To test the visibility of the first triangle 12 within tile (7,4), the depth value stored in the Coarse-Z buffer (7,4) is accessed and compared with the depth values of the first triangle 12 within tile (7,4). Because the maximum depth value of the first triangle within tile (7,4) is less than the depth value in the Coarse-Z buffer (7,4), the area of the first triangle 12 within tile (7,4) is determined to be in the foreground. The depth value stored in the Coarse-Z buffer (7,4) is updated with 0.4. Afterwards there is no demand to perform the pixel-by-pixel visibility test of the first triangle 12 within tile (7,4).

Further assume that the maximum and minimum depth values of the second triangle 14 within tile (7,4) are 0.9 and 0.6. The maximum depth value of the second triangle 14 within tile (7,4) is compared with the value stored in Coarse-Z buffer (7,4). Since the maximum depth values of the second triangle 14 within tile (7,4) are greater than the depth value 0.4 in the Coarse-Z buffer (7,4), the second triangle 14 is not visible.

The required memory bandwidth of the tile-based visibility preprocessing is less than that of Z-buffer technology. For example, the size of tile is 32*32(1024 pixels), there are 768 elements in the Coarse-Z buffer (assume the resolution is 1024*768). Relative to the size of Z-buffer technology, the size of Coarse-Z buffer and the required memory bandwidth is quite small.

The tile-based visibility preprocess is accomplished by determining the depth value of a polygon and comparing it with value in the Coarse-Z buffer. If the polygon within a particular group of tiles is hidden, there will be no demand to perform the pixel-by-pixel visibility test.

### SUMMARY OF THE INVENTION

The present invention provides a method for reducing memory consumption and process overhead in a graphics rendering system. In accordance with the present invention, the visibility preprocessor performs a triangle-based visibility test. A minimum depth value, Zmin, of a triangle is selected to represent the depth information of the entire triangle. Preferably, the minimum depth value of a triangle is defined to be the minimum depth value between the vertices of a triangle. If the triangle within a particular group of tiles is hidden, the triangle will be discarded.

The method above significantly reduces rendering overhead, since it eliminates required memory bandwidth of visibility test and the need to generate pixels being hidden. This enables the system to render a scene more quickly, which is particularly beneficial in a real time system.

Further advantages and features of the present invention will become apparent with reference to the following detailed description and accompanying drawing.

### BRIEF DESCRIPTION OF THE DRAWINGS

FIG. 1 shows one triangle in the foreground and another one in the background.

FIG. 2 shows an example of the tile-based visibility test with Coarse-Z buffer.

FIG. 3 shows a block diagram of the 3D graphics engine.

FIG. 4 illustrates the triangle-based visibility pre-test.

FIGS. 5A, 5B respectively show preferred embodiments in accordance with the present invention.

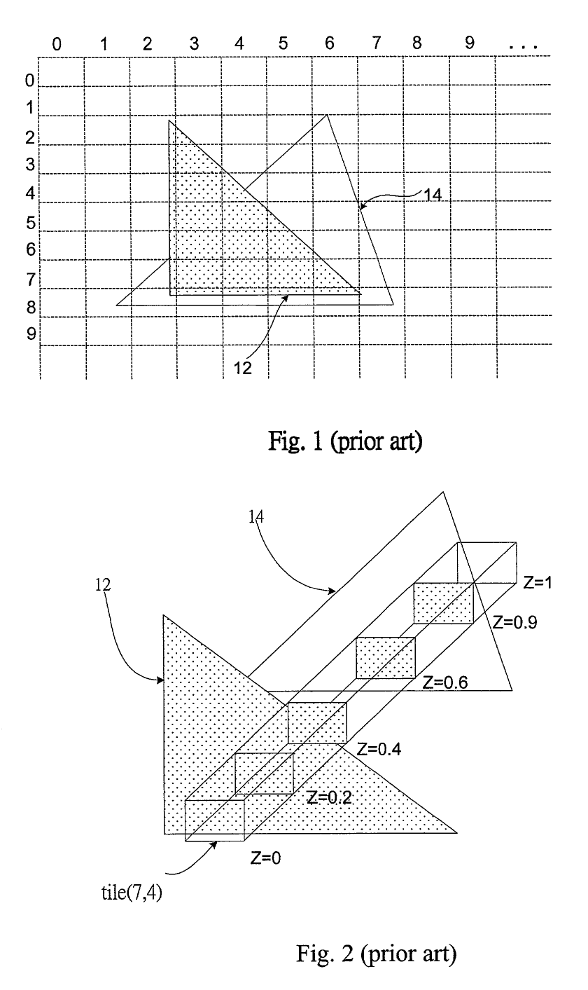

### DETAILED DESCRIPTION OF THE INVENTION

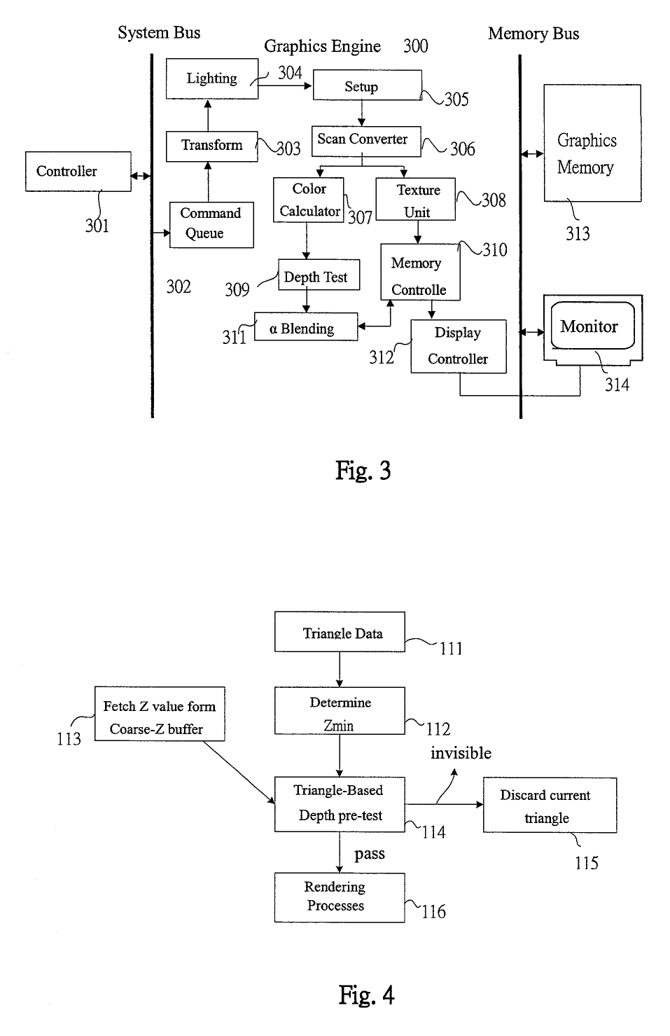

As shown in FIG. 3, a 3D graphics engine 300 typically can be divided into several stages in a pipeline: transformation 303, lighting 304, setup 305, scan converter 306, color calculator 307 and texture pipeline 308. The 3D graphics engine 300 receives data including the coordinates, colors and depth values of the 3D objects from the Command Queue 302. The transformation 303 performs the transform of the coordinates. And the lighting 304 performs the lighting of colors.

Further, the 3D graphics engine 300 performs a setup operation 305 for each triangle. The 3D graphics engine 300 includes a setup engine for preparing and calculating the parameters of the primitives. After the setup of the triangle is finished, all the parameters of the primitives are sent to the next stage.

Next stage includes a color calculator 307, a texture unit 308, a depth test 309, an alpha blending 311, etc. The color calculator 307 outputs a sequence of pixel colors representing the color of primitive. After performing the depth test 309, the pixel undergoes the alpha blending 311.

The 3D graphics engine 300 receives and executes the commands stored in the command queue 302. The memory controller 310 accesses the graphics memory 313 via the memory bus. The command queue 302 is a FIFO unit for storing command data received from the controller 301 via the system bus.

Hidden surface removal is an important technique of how a 3D graphics engine performs visibility checks. By detecting invisible pixels and/or polygons, the 3D graphics system can remove the hidden surface from an engine's rendering pipeline at an early stage. This approach reduces reducing unnecessary computations and requirement of memory bandwidth.

The presented triangle occlusion culling technique, which performs fast triangle-based visibility test, is particularly applicable to front-end hidden surface removal. In FIG. 4, a fast triangle occlusion culling technique is introduced. Beside the depth test in conventional pipeline, a triangle-based visibility pre-test is performed to remove triangles that are hidden. Prior to the setup stage of rendering process, the depth pre-test compares the depth value retrieved from Coarse-Z buffer with a specific depth value Zmin of the triangle. According to the result of depth pre-test, if a triangle is determined to be hidden, the triangle will be discarded. If no decision can be made, the triangle will be sent to the following stages for other operations. The value of Zmin is the minimum depth values between the triangle vertices.

The computer graphics system of the present invention defines a reference coordinate system including M tiles. Each of the tiles corresponds to a predetermined depth value stored in a Z-buffer. A triangle covers N tiles. The triangle-based pre-test algorithm shown in FIG. 4 is described as follow:

step 111: accessing date of the triangle, the data including the vertex coordinates of the triangle (Xₙ, Yₙ, Zₙ), n=1˜3;

step 112: determining the minimum depth value of the triangle Zmin from the vertex coordinates (Xₙ, Yₙ, Zₙ);

step 113: comparing Zmin with the predetermined depth values stored in the Z-buffer of the N tiles;

step 114: if the Zmin is greater than the predetermined depth values stored in the Z-buffer of the N tiles, discarding the data of the triangle, otherwise, performing the following step 116;

step 116: performing the rendering processes.

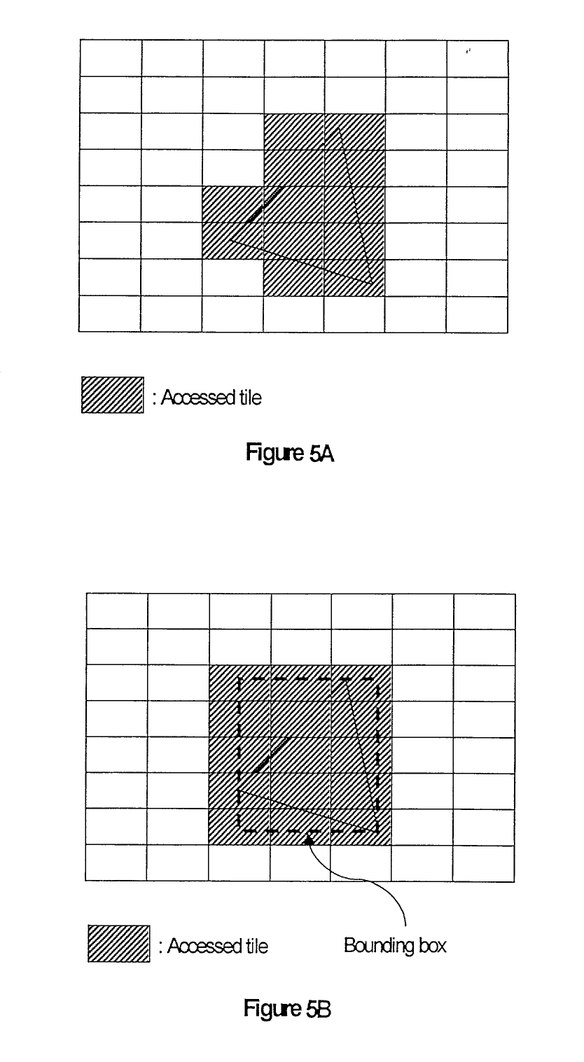

Refer now to FIG. 5A, when the triangle covers N tiles, the present invention compares the Zmin with the predetermined depth values of the N tiles stored in Z-buffer. Another embodiment shown in FIG. 5B performs a depth test by choosing the tiles covered by a reference rectangle defined by the triangle vertices.

What is claimed is:

1. A method for accelerated triangle occlusion culling the computer graphic system, said computer graphics system defining a reference coordinate system, said reference coordinate system including M tiles, each of the tiles corresponding to a predetermined depth value stored in a Z-buffer, a triangle covering N tiles, said method comprising the following steps:
accessing data of said triangle, said data including the vertex coordinates of said triangle;
determining a minimum depth value Zmin of said triangle from said vertex coordinates;
comparing said minimum depth value with the predetermined depth values stored in said Z-buffer of said N tiles;
processing said data of said triangle according to the result of the comparison.

2. The method of claim 1, if said minimum depth value is greater than said predetermined depth values stored in said Z-buffer of said N tiles, discarding said triangle data.

3. The method of claim 1, if said minimum depth value is smaller than said predetermined depth values stored in said Z-buffer of said N tiles, performing a rendering process.

4. The method of claim 1, wherein said tiles covered by said triangle are determined by a reference rectangle defined by said triangle vertices.
